(19) United States
(12) Patent Application Publication
(10) Pub. No.: US 2017/0059317 A1
(43) Pub. Date: Mar. 2, 2017

(54) SYSTEM AND METHOD FOR AUTOMATICALLY GENERATING CAD FIELD SKETCHES AND AUTOMATIC VALIDATION THEREOF

(71) Applicant: Datumate Ltd., Nazareth (IL)

(72) Inventors: Jad JARROUSH, Nazareth Illit (IL); Haim ZELIKOVSKY, Hod Hasharon (IL)

(73) Assignee: Datumate Ltd., Nazareth (IL)

(21) Appl. No.: 15/307,442

(22) PCT Filed: May 6, 2015
(86) PCT No.: PCT/IL15/50474

§ 371 Date: Oct. 28, 2016

Related U.S. Application Data
(60) Provisional application No. 61/989,619, filed on May 7, 2014.

(51) Int. Cl. G01C 11/04; G06F 17/50; G06T 7/60

(52) U.S. Cl. CPC G01C 11/04; G06T 7/60; G06F 17/50; G06T 2207/10004

(57) ABSTRACT

A method for automatically validating measurements of a field survey including providing, on a field computing device, a two-dimensional image of a field to be surveyed, providing actual coordinates of at least two field reference points, each corresponding to an image reference point on the two-dimensional image, employing the field computing device to outline, on the two-dimensional image, features of interest of the field, employing the field computing device to manually select, on the outline, a plurality of image measuring points, for each image measuring point, identifying a corresponding field measuring point, measuring the actual coordinates of each field measuring point, thereby obtaining actual coordinates thereof, and responsive to the obtaining, automatically ascertaining for each image measuring point and corresponding field measuring point, whether there is a discrepancy between the location of the image measuring point on the two-dimensional image and the actual coordinates of the corresponding field measuring point.

### REFERENCE TO RELATED APPLICATIONS

Reference is hereby made to U.S. Provisional Patent Application Ser. No. 61/989,619, filed May 7, 2014 and entitled “SYSTEM AND METHOD FOR AUTOMATICALLY GENERATING CAD FIELD SKETCHES AND AUTOMATIC VALIDATION THEREOF”, the disclosure of which is incorporated by reference in its entirety and priority of which is hereby claimed pursuant to 37 CFR 1.78(a) (4) and (5)(i).

Reference is also made to U.S. Pat. No. 8,458,140, owned by assignee, the disclosure of which are hereby incorporated by reference, which is believed to relate to subject matter related to the subject matter of the present application:

### FIELD OF THE INVENTION

The present invention relates to systems and methods for executing surveys, such as land surveys, engineering surveys and construction surveys.

### BACKGROUND OF THE INVENTION

Current methods of executing surveys typically include generating a field sketch by manually sketching an area of a field to be surveyed, naming and selecting a plurality of measuring points on the field sketch for which coordinate data is to be obtained, and obtaining the coordinate data corresponding to the measuring points by measuring the measuring points in the field using well-known field measuring techniques. It is appreciated that the field sketch is typically drawn relative to at least one well known reference point such as a cadastral reference point or a licensed control point.

Features of interest, such as topographical or structural features located in the field, are typically depicted by polylines and polygons and by subsets of the selected measuring points, wherein the polylines and polygons are typically generated by connecting individual ones of the measuring points on the field sketch.

Typically, the surveying crew includes at least two individuals, wherein one individual is tasked with drawing the sketch and another individual is tasked with measuring the previously selected measuring points by employing a geodetic measurement device such as, for example, a total station, a Global Positioning System (GPS) Real Time Kinetic (RTK) or any other suitable geodetic measurement device. Alternatively, the surveying crew may include only one individual tasked with drawing the sketch and supervising automatic measurement of the previously selected measuring points by a robotic geodetic measurement device. As described hereinabove and as shown in FIG. 1, the polylines and the polygons preferably outline the topology of the ground surface as well as features of interest located in the field.

The manual method described hereinabove is deemed to be error-prone, as the accuracy of the resulting survey is dependent on the accuracy of the manual sketch. An inaccurate sketch may result in a survey wherein the location of a measuring point on the sketch may not correspond to the actual location of the measured point as measured in the field. Furthermore, as described above, since the features of interest in the field are typically depicted by polylines and polygons as well as by connecting measuring points on the field sketch, errors may also arise from incompatibility between a label or a name of a measuring point as saved in the geodetic measurement device and a label or a name of the corresponding measuring point on the field sketch, as shown in FIG. 2, which shows measuring points 1-17 as saved in a geodetic measurement device and actual survey points 1-18, and in which actual survey points 14-18 do not match measuring points 14-17 as saved in the geodetic measurement device.

Additionally, when employing the manual method described hereinabove, the surveyor in the field may erroneously omit from the manual sketch one or more significant topographical or structural features of the area in the field to be surveyed, thereby leading, in turn, to a survey which is lacking measurements corresponding to the omitted features. The result is a time-consuming and relatively expensive process, wherein the surveyor must return to the field multiple times to measure the omitted features.

### SUMMARY OF THE INVENTION

The present invention seeks to provide an improved system and method for executing surveys, such as land surveys, engineering surveys and construction surveys.

There is thus provided in accordance with a preferred embodiment of the present invention a method for automatically validating measurements of a field survey, the method including providing, on a field computing device, a two-dimensional image of a field to be surveyed, providing actual coordinates of at least two field reference points in the field, each of the at least two field reference points corresponding to an image reference point on the two-dimensional image, employing the field computing device to outline, on the two-dimensional image, features of interest of the field to be surveyed, employing the field computing device to manually select, on the outline, a plurality of image measuring points, for each image measuring point of the plurality of image measuring points, identifying, in the field, a corresponding field measuring point, measuring, in the field, the actual coordinates of each the field measuring point, thereby obtaining actual coordinates of each the field measuring point and responsive to obtaining actual coordinates of each the field measuring point, automatically ascertaining, by a computer, for each the image measuring point and the corresponding field measuring point, whether there is a discrepancy between the location of the image measuring point on the two-dimensional image and the actual coordinates of the corresponding field measuring point.

Preferably, the measuring, in the field, the actual coordinates of each the field measuring point, also includes measuring, in the field, actual distances and angles between vertexes of the outline and each the field measuring point.

In accordance with a preferred embodiment of the present invention the employing the field computing device to outline, on the two-dimensional image, features of interest of the field to be surveyed, includes employing the field computing device to manually outline, on the two-dimensional image, features of interest of the field to be surveyed. Alternatively or additionally, the employing the field computing device to outline, on the two-dimensional image, features of interest of the field to be surveyed, includes employing the field computing device to automatically outline, on the two-dimensional image, features of interest of the field to be surveyed.

In accordance with a preferred embodiment of the present invention the method for automatically validating a survey also includes, responsive to the obtaining the actual coordinates of each the field measuring point, automatically employing the actual coordinates of each the field measuring point to automatically indicate, on the two-dimensional image, an actual location of the field measuring point.

Preferably, the method for automatically validating a survey also includes, responsive to ascertaining, for at least one the image measuring point and the corresponding field measuring point, that there is a discrepancy between the location of the image measuring point on the two-dimensional image and the actual coordinates of the corresponding field measuring point, automatically modifying the outline on the two-dimensional image to coincide with the actual coordinates of the corresponding field measuring point.

In accordance with a preferred embodiment of the present invention the two-dimensional image is a photograph of the field to be surveyed. Alternatively, the two-dimensional image is a manually drawn sketch of the field to be surveyed.

Preferably, the field computing device is a handheld computer.

In accordance with a preferred embodiment of the present invention the automatically ascertaining, for each the image measuring point and the corresponding field measuring point, whether there is a discrepancy between the location of the image measuring point on the two-dimensional image and the actual coordinates of the corresponding field measuring point, is performed by the field computing device.

In accordance with an alternative preferred embodiment of the present invention, the automatically ascertaining, for each the image measuring point and the corresponding field measuring point, whether there is a discrepancy between the location of the image measuring point on the two-dimensional image and the actual coordinates of the corresponding field measuring point, is performed by a computer other than the field computing device, the computer communicating with the field computing device. Additionally, the computer is remotely located from the field computing device and is operative for real-time communication therewith.

Preferably, survey data including at least one of the two-dimensional image of the field, the outline of the features of interest on the two-dimensional image, the plurality of image measuring points and the actual coordinates of the field measuring points is transmitted to a remote computing device, the remote computing device located at a remote location which is remote from the field. Additionally, the method for automatically validating a survey also includes reviewing of the survey data by personnel at the remote location.

In accordance with a preferred embodiment of the present invention the reviewing includes at least one of ascertaining that the survey does not include a sufficient number of measuring points and ascertaining that the survey does not include at least one significant measuring point. Additionally or alternatively, the reviewing includes ascertaining whether the survey data is sufficient to complete the survey. Additionally or alternatively, the reviewing also includes real-time alerting of personnel in the field, by the personnel at the remote location, that the data is insufficient to complete the survey, and to prompt the personnel in the field to collect additional data.

Preferably, the reviewing also includes remotely updating, by the personnel at the remote location, on the field computing device, at least some of the survey data.

There is also provided in accordance with another preferred embodiment of the present invention a system for automatically validating measurements of a field survey, the system including image outlining functionality operative for facilitating outlining, on a two-dimensional image of a field to be surveyed, features of interest of the field to be surveyed, measuring point selection functionality operable for facilitating manual selection, on the outline, of a plurality of measuring points and computerized measuring point discrepancy ascertaining functionality operable, responsive to obtaining actual coordinates of each the measuring point, for automatically ascertaining, for each the measuring point, whether there is a discrepancy between the location of the measuring point on the two-dimensional image and actual measured coordinates of the measuring point.

Preferably, the obtaining the actual coordinates of each the field measuring point, also includes obtaining actual distances and angles between vertexes of the outline and each the field measuring point.

In accordance with a preferred embodiment of the present invention the image outlining functionality is operative for facilitating manually outlining, on the two-dimensional image of the field to be surveyed, features of interest of the field to be surveyed. Alternatively or additionally, the image outlining functionality is operative for facilitating automatically outlining, on the two-dimensional image of the field to be surveyed, features of interest of the field to be surveyed.

Preferably, the computerized measuring point discrepancy ascertaining functionality is also operable, responsive to the obtaining the actual coordinates of each the measuring point, for automatically employing the actual coordinates of each the measuring point to automatically indicate, on the two-dimensional image, an actual location of the measuring point.

In accordance with a preferred embodiment of the present invention the computerized measuring point discrepancy ascertaining functionality is also operable, responsive to the ascertaining, for at least one of the measuring points, that there is a discrepancy between the location of the measuring point on the two-dimensional image and the actual coordinates of the measuring point, for automatically modifying the outline on the two-dimensional image to coincide with the actual coordinates of the measuring point.

Preferably, the two-dimensional image is a photograph of the field to be surveyed. Alternatively, the two-dimensional image is a manually drawn sketch of the field to be surveyed.

In accordance with a preferred embodiment of the present invention the field computing device is a handheld computer.

In accordance with a preferred embodiment of the present invention the measuring point discrepancy ascertaining functionality is hosted on the field computing device. Alternatively, the measuring point discrepancy ascertaining functionality is hosted on a computer other than the field computing device, the computer communicating with the field computing device. Preferably, the computer is remotely located from the field computing device and is operative for real-time communication therewith.

In accordance with a preferred embodiment of the present invention survey data including at least one of the two-dimensional image of the field, the outline of the features of interest on the two-dimensional image, the plurality of measuring points and the actual coordinates of the measuring points is transmitted to a remote computing device, the remote computing device located at a remote location which is remote from the field.

Preferably, the system for automatically validating a survey also includes remote reviewing functionality operable for remote review of the survey data by personnel at the remote location. Additionally, the reviewing functionality is also operable for at least one of ascertaining that the survey does not include a sufficient number of measuring points and ascertaining that the survey does not include at least one significant measuring point. Additionally or alternatively, the reviewing functionality is also operable for ascertaining whether the survey data is sufficient to complete the survey.

In accordance with a preferred embodiment of the present invention the reviewing functionality is also operable for real-time alerting of personnel in the field, by the personnel at the remote location, that the data is insufficient to complete the survey, and to prompt the personnel in the field to collect additional data. Additionally or alternatively, the reviewing functionality is also operable for remotely updating, by the personnel at the remote location, on the field computing device, at least some of the survey data.

### BRIEF DESCRIPTION OF THE DRAWINGS

The present invention will be understood and appreciated more fully from the following detailed description, taken in conjunction with the drawings in which:

FIG. 1 is a simplified pictorial illustration of a manual sketch of an area of a field to be surveyed, including polylines and polygons outlining topology of the ground surface as well as features of interest located in the area;

FIG. 2 is a simplified pictorial illustration of a field sketch of the area of FIG. 1 including measuring points and actual survey points;

FIG. 3 is a simplified illustration of a survey including field measuring points 1-11 and showing distances between different ones of the points of interest;

FIG. 4 is a simplified pictorial illustration showing a manual outline of features of interest to be surveyed on a two-dimensional image of an area to be surveyed;

FIG. 5 is a simplified pictorial illustration showing manual selection of a plurality of image measuring points, numbered 1-20 on an outline of an two-dimensional image of an area to be surveyed;

FIG. 6 is a simplified illustration of automatic indication of actual location functionality of the present invention; and

FIG. 7 is a simplified illustration of automatic outline modification functionality of the present invention.

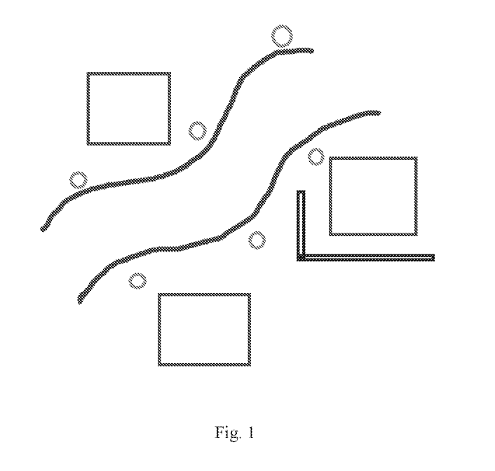

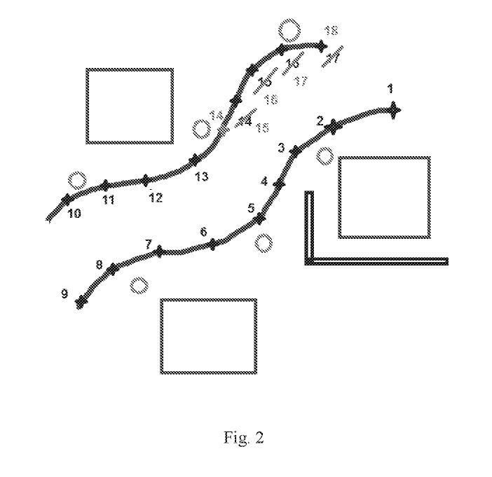

### DETAILED DESCRIPTION OF PREFERRED EMBODIMENTS

The present invention seeks to provide an improved system and method for executing surveys, such as land surveys, engineering surveys and construction surveys.

The present invention seeks to provide an improved system and method for executing surveys, which guarantees accurate correlation between an initial sketch of an area being surveyed and coordinate data resulting from the measuring process. Additionally, the present invention enables iterative real-time review of the survey by a consultant remotely located from the field, thereby enabling the consultant to provide real-time feedback to the surveyor and thereby enabling the surveyor in the field to perform additional measurements as may be needed, before leaving the field.

The method of the present invention preferably includes:

providing, on a field computing device, a two-dimensional image of a field to be surveyed;

providing actual coordinates of at least two field reference points in the field, each of the at least two field reference points corresponding to an image reference point on the two-dimensional image;

employing the field computing device to manually or automatically outline, on the two-dimensional image, features of interest of the field to be surveyed;

employing the field computing device to manually select, on the outline, a plurality of image measuring points;

for each image measuring point of the plurality of image measuring points, identifying, in the field, a corresponding field measuring point;

measuring, in the field, the actual coordinates of each field measuring point, thereby obtaining actual coordinates of each field measuring point; and

responsive to obtaining actual coordinates of each field measuring point, automatically ascertaining, by a computer, for each image measuring point and the corresponding field measuring point, whether there is a discrepancy between the location of the image measuring point on the two-dimensional image and the actual coordinates of the corresponding field measuring point.

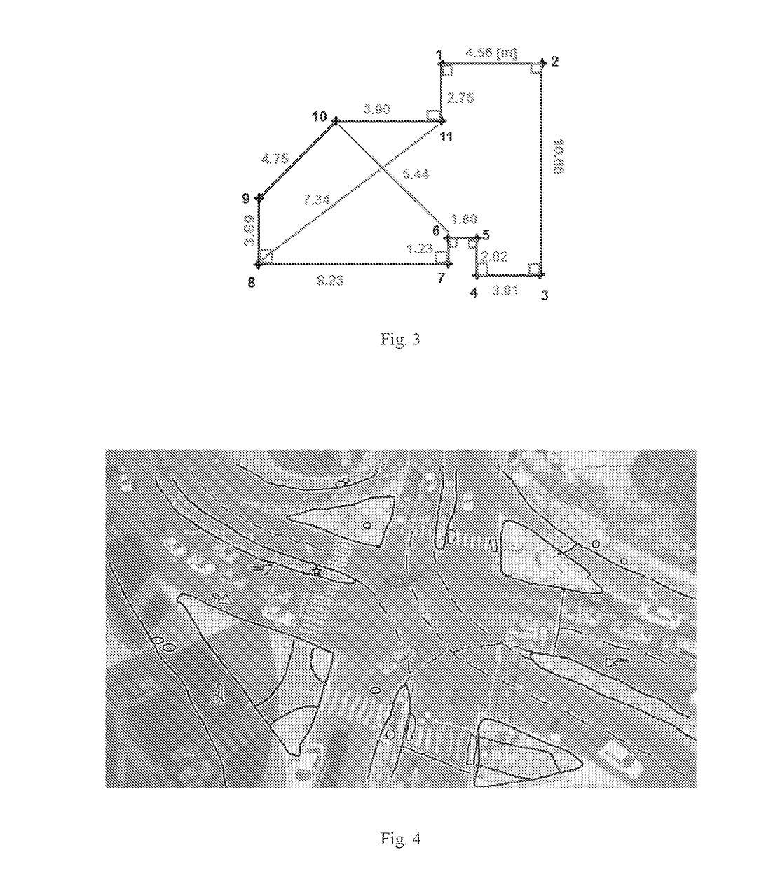

It is appreciated that measuring, in the field, the actual coordinates of each field measuring point, to obtain actual coordinates of each field measuring point, also includes measuring, in the field, the actual distances and angles between vertexes of the outline and each of the field measuring points, as illustrated in FIG. 3.

FIG. 4 illustrates the steps of providing the two-dimensional image of the field to be surveyed and manually outlining, on the two-dimensional image, the features of interest to be surveyed.

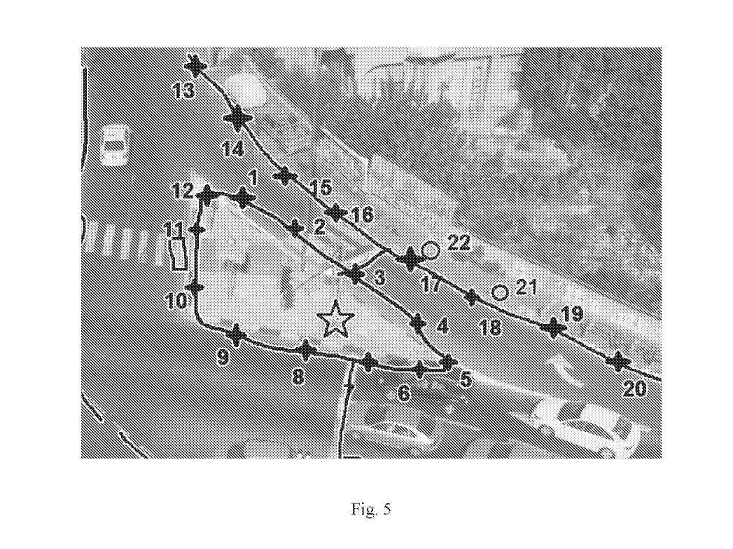

FIG. 5 illustrates the step of manually selecting, on the outline, the plurality of image measuring points.

It is appreciated that a measurement point snap-in tool is preferably provided on the field computing device, which is preferably operative to facilitate automatic snap-in of the manually selected measuring points to a closest point on the outline.

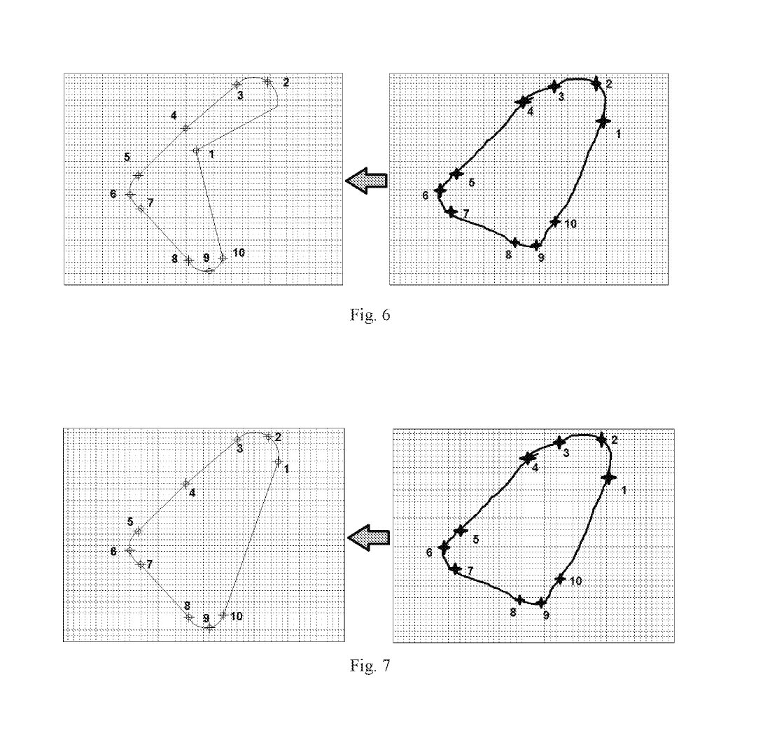

It is a particular feature of the present invention that the method also includes, responsive to obtaining the actual coordinates of each field measuring point, automatically employing the actual coordinates of each field measuring point to automatically indicate, on the two-dimensional image, an actual location of the field measuring point. This feature is illustrated in FIG. 6.

It is a further particular feature of the present invention that, responsive to ascertaining, for at least one image measuring point and a corresponding field measuring point, that there is a discrepancy between the location of the image measuring point on the two-dimensional image and the actual coordinates of the corresponding field measuring point, automatically modifying the outline on the two-dimensional image to coincide with the actual coordinates of the corresponding field measuring point. This feature is illustrated in FIG. 7.

It is appreciated that the field computing device employed in the field may be a handheld computer, such as a tablet computer. It is further appreciated that the two-dimensional image may be, for example, an aerial photograph of the field or a pre-existing map of the field.

It is further appreciated that obtaining of the actual coordinates of each field measuring point may be achieved by employing any well known field measuring method or system, such as employing readily available GPS coordinates or Total Station coordinates computations. The actual coordinates may be transferred from the measuring device to the field computing device manually or electronically, or by physically importing a digital file including the actual coordinates, into the field computing device. The measuring device may communicate with the field computing device either via a wired or a wireless connection. Alternatively, the measuring device may be integrally provided with the field computing device.

It is yet further appreciated that automatically ascertaining, for each image measuring point and corresponding field measuring point, whether there is a discrepancy between the location of the image measuring point on the two-dimensional image and the actual coordinates of the corresponding field measuring point, may be performed by the field computing device, or by a computer other than the field computing device, which computer communicates with the field computing device.

It is yet another particular feature of the present invention that at least one of:

the two-dimensional image of the field;

the outline of the features of interest on the two-dimensional image;

the plurality of image measuring points; and

the actual coordinates of the field measuring points is transmitted to a remote computing device, the remote computing device located at a location which is remote from the field.

It is appreciated that the availability of the data mentioned hereinabove at a remote computing device is operative to facilitate the review of the data by personnel in that remote location. For example, a supervisor in an office may notice that the surveyor in the field has not marked a sufficient number of measuring points for measurement, or that he has omitted one or more key features of the field from the survey. The supervisor may then alert the surveyor, in real time, while the latter is still in the field, that data is lacking from the survey, enabling the surveyor to collect the lacking data before leaving the field.

It is yet a further particular feature of the present invention that the availability of the data mentioned hereinabove at a remote computing device is also operative to facilitate adding, by the remotely located supervisor, on the field computing device, the missing measuring points or features to the two-dimensional image of the surveyor, thereby further assisting the surveyor to collect the lacking data before leaving the field.

It is appreciated that the completed survey is preferably digitally saved, for example, in the form of a CAD file produced by the surveyor in the field. The saved survey may then be uploaded to an internet cloud, where it may then be remotely accessed and viewed by employing suitable viewing software in real time.

It will be appreciated by persons skilled in the art that the present invention is not limited by what has been specifically shown and described hereinabove. Rather the scope of the invention includes both combinations and sub-combinations of features described and shown hereinabove as well as modifications thereof which would occur to persons reading the foregoing description and which are not in the prior art.

1. A method for automatically validating measurements of a field survey, said method comprising:
providing, on a field computing device, a two-dimensional image of a field to be surveyed;
providing actual coordinates of at least two field reference points in said field, each of said at least two field reference points corresponding to an image reference point on said two-dimensional image;
employing said field computing device to outline, on said two-dimensional image, features of interest of said field to be surveyed;
employing said field computing device to manually select, on said outline, a plurality of image measuring points;
for each image measuring point of said plurality of image measuring points, identifying, in said field, a corresponding field measuring point;
measuring, in said field, the actual coordinates of each said field measuring point, thereby obtaining actual coordinates of each said field measuring point; and
responsive to obtaining actual coordinates of each said field measuring point, automatically ascertaining, by a computer, for each said image measuring point and said corresponding field measuring point, whether there is a discrepancy between the location of said image measuring point on said two-dimensional image and said actual coordinates of said corresponding field measuring point.

2. A method for automatically validating a survey according to claim 1 and wherein said measuring, in said field, said actual coordinates of each said field measuring point, also comprises measuring, in said field, actual distances and angles between vertexes of said outline and each said field measuring point.

3. A method for automatically validating a survey according to claim 1 and wherein said employing said field computing device to outline, on said two-dimensional image, features of interest of said field to be surveyed, comprises employing said field computing device to manually outline, on said two-dimensional image, features of interest of said field to be surveyed.

4. A method for automatically validating a survey according to claim 1 and wherein said employing said field computing device to outline, on said two-dimensional image, features of interest of said field to be surveyed, comprises employing said field computing device to automatically outline, on said two-dimensional image, features of interest of said field to be surveyed.

5. A method for automatically validating a survey according to claim 1 and also comprising:
responsive to said obtaining said actual coordinates of each said field measuring point, automatically employing said actual coordinates of each said field measuring point to automatically indicate, on said two-dimensional image, an actual location of said field measuring point.

6. A method for automatically validating a survey according to claim 1 and also comprising:
responsive to ascertaining, for at least one said image measuring point and said corresponding field measuring point, that there is a discrepancy between said location of said image measuring point on said two-dimensional image and said actual coordinates of said corresponding field measuring point, automatically modifying said outline on said two-dimensional image to coincide with said actual coordinates of said corresponding field measuring point.

7. A method for automatically validating a survey according to claim 1 and wherein said two-dimensional image is a photograph of said field to be surveyed.

8. A method for automatically validating a survey according to claim 1 and wherein said two-dimensional image is a manually drawn sketch of said field to be surveyed.

9. A method for automatically validating a survey according to claim 1 and wherein said field computing device is a handheld computer.

10. A method for automatically validating a survey according to claim 1 and wherein said automatically ascertaining, for each said image measuring point and said corresponding field measuring point, whether there is a discrepancy between the location of said image measuring point on said two-dimensional image and said actual coordinates of said corresponding field measuring point, is performed by said field computing device.

11. A method for automatically validating a survey according to claim 1 and wherein said automatically ascertaining, for each said image measuring point and said corresponding field measuring point, whether there is a discrepancy between the location of said image measuring point on said two-dimensional image and said actual coordinates of said corresponding field measuring point, is performed by a computer other than said field computing device, said computer communicating with said field computing device.

12. A method for automatically validating a survey according to claim 11 and wherein said computer is remotely located from said field computing device and is operative for real-time communication therewith.

13. A method for automatically validating a survey according to claim 1 and wherein survey data comprising at least one of:
said two-dimensional image of said field;
said outline of said features of interest on said two-dimensional image;
said plurality of image measuring points; and
said actual coordinates of said field measuring points is transmitted to a remote computing device, said remote computing device located at a remote location which is remote from said field.

14. A method for automatically validating a survey according to claim 13 and also comprising reviewing of said survey data by personnel at said remote location.

15. A method for automatically validating a survey according to claim 14 and wherein said reviewing comprises at least one of:
ascertaining that said survey does not comprise a sufficient number of measuring points; and
ascertaining that said survey does not comprise at least one significant measuring point.

16. A method for automatically validating a survey according to claim 14 and wherein said reviewing comprises ascertaining whether said survey data is sufficient to complete said survey.

17. A method for automatically validating a survey according to claim 16 and wherein said reviewing also comprises real-time alerting of personnel in said field, by said personnel at said remote location, that said data is insufficient to complete said survey, and to prompt said personnel in said field to collect additional data.

18. A method for automatically validating a survey according to claim 14 and wherein said reviewing also comprises remotely updating, by said personnel at said remote location, on said field computing device, at least some of said survey data.

19. A system for automatically validating measurements of a field survey, said system comprising:
image outlining functionality operative for facilitating outlining, on a two-dimensional image of a field to be surveyed, features of interest of said field to be surveyed;
measuring point selection functionality operable for facilitating manual selection, on said outline, of a plurality of measuring points; and
computerized measuring point discrepancy ascertaining functionality operable, responsive to obtaining actual coordinates of each said measuring point, for automatically ascertaining, for each said measuring point, whether there is a discrepancy between the location of said measuring point on said two-dimensional image and actual measured coordinates of said measuring point.

20. A system for automatically validating a survey according to claim 19 and wherein said obtaining said actual coordinates of each said field measuring point, also comprises obtaining actual distances and angles between vertexes of said outline and each said field measuring point.

21. A system for automatically validating a survey according to claim 19 and wherein said image outlining functionality is operative for facilitating manually outlining, on said two-dimensional image of said field to be surveyed, features of interest of said field to be surveyed.

22. A system for automatically validating a survey according to claim 19 and wherein said image outlining functionality is operative for facilitating automatically outlining, on said two-dimensional image of said field to be surveyed, features of interest of said field to be surveyed.

23. A system for automatically validating a survey according to claim 19 and wherein said computerized measuring point discrepancy ascertaining functionality is also operable, responsive to said obtaining said actual coordinates of each said measuring point, for automatically employing said actual coordinates of each said measuring point to automatically indicate, on said two-dimensional image, an actual location of said measuring point.

24. A system for automatically validating a survey according to claim 19 and wherein said computerized measuring point discrepancy ascertaining functionality is also operable, responsive to said ascertaining, for at least one said measuring point, that there is a discrepancy between said location of said measuring point on said two-dimensional image and said actual coordinates of said measuring point, for automatically modifying said outline on said two-dimensional image to coincide with said actual coordinates of said measuring point.

25. A system for automatically validating a survey according to claim 19 and wherein said two-dimensional image is a photograph of said field to be surveyed.

26. A system for automatically validating a survey according to claim 19 and wherein said two-dimensional image is a manually drawn sketch of said field to be surveyed.

27. A system for automatically validating a survey according to claim 19 and wherein said field computing device is a handheld computer.

28. A system for automatically validating a survey according to claim 19 and wherein said measuring point discrepancy ascertaining functionality is hosted on said field computing device.

29. A system for automatically validating a survey according to claim 19 and wherein said measuring point discrepancy ascertaining functionality is hosted on a computer other than said field computing device, said computer communicating with said field computing device.

30. A system for automatically validating a survey according to claim 29 and wherein said computer is remotely located from said field computing device and is operative for real-time communication therewith.

31. A system for automatically validating a survey according to claim 19 and wherein survey data comprising at least one of:
said two-dimensional image of said field;
said outline of said features of interest on said two-dimensional image;
said plurality of measuring points; and
said actual coordinates of said measuring points are transmitted to a remote computing device, said remote computing device located at a remote location which is remote from said field.

32. A system for automatically validating a survey according to claim 31 and also comprising remote reviewing functionality operable for remote review of said survey data by personnel at said remote location.

33. A system for automatically validating a survey according to claim 32 and wherein said reviewing functionality is also operable for at least one of:
ascertaining that said survey does not comprise a sufficient number of measuring points; and
ascertaining that said survey does not comprise at least one significant measuring point.

34. A system for automatically validating a survey according to claim 32 and wherein said reviewing functionality is also operable for ascertaining whether said survey data is sufficient to complete said survey.

35. A system for automatically validating a survey according to claim 34 and wherein said reviewing functionality is also operable for real-time alerting of personnel in said field, by said personnel at said remote location, that said data is insufficient to complete said survey, and to prompt said personnel in said field to collect additional data.

36. A system for automatically validating a survey according to claim 32 and wherein said reviewing functionality is also operable for remotely updating, by said personnel at said remote location, on said field computing device, at least some of said survey data.
